(19) United States
(12) Patent Application Publication
(10) Pub. No.: US 2026/0203933 A1
(43) Pub. Date: Jul. 16, 2026

(54) POSE ESTIMATION SYSTEM, POSE ESTIMATION METHOD, AND PROGRAM

(71) Applicant: Sony Interactive Entertainment Inc., Tokyo (JP)

(72) Inventors: Katsuhiko Matsuura, Tokyo (JP); Shogo Sato, Tokyo (JP); Yasushi Okumura, Tokyo (JP); Tetsugo Inada, Tokyo (JP)

(21) Appl. No.: 19/562,573

(22) Filed: Mar. 10, 2026

Related U.S. Application Data
(63) Continuation of application No. PCT/JP2023/033602, filed on Sep. 14, 2024.

(51) Int. Cl. G06T 7/73; G06V 10/70

(52) U.S. Cl. CPC G06T 7/73; G06V 10/70; G06T 2207/20081

(57) ABSTRACT

Pose estimation using keypoints is performed in a more appropriate manner. A pose estimation system acquires information indicating a portion of an object hidden by a hand (S204, S402), decides three-dimensional positions of a plurality of keypoints for estimating a pose of the object, on the basis of the information (S208, S405), trains a machine learning model for estimating the decided positions of the plurality of keypoints in an input image (S203, S407), on the basis of an output when an image including the object and the hand is input to the trained machine learning model, acquires estimated positions of the keypoints in the image, and, on the basis of the estimated positions of the keypoints, decides an estimated pose of the object in a three-dimensional space.

### CROSS-REFERENCE TO RELATED APPLICATIONS

This application is a Continuation of International Application No. PCT/JP2023/033602, having an International Filing Date of September 14, 2024. This disclosure of the prior application is considered part of the disclosure of this application.

### FIELD

The present specification relates to a pose estimation system, a pose estimation method, and a program.

### BACKGROUND

There is a technique of estimating positions of keypoints of an object from an image obtained by imaging the object and estimating a pose of the object from the estimated keypoints. Three-dimensional positions of the keypoints of the object are decided in advance.

For example, a machine learning model for estimating positions of keypoints in an image is trained, and by use of the trained machine learning model, positions of keypoints in a captured image are estimated from the captured image.

### SUMMARY

When pose estimation is to be performed, it is sometimes difficult to estimate positions of keypoints from an image since, for example, an object is hidden by a hand. This might cause a reduction in accuracy of pose estimation or a reduction in processing speed.

The present specification has been made in view of the above circumstances and has as an object thereof provision of a technology for enabling pose estimation to be performed in a more appropriate manner.

In order to solve the above problem, according to the present specification, there is provided a pose estimation system including one or a plurality of processors configured to acquire information indicating a portion of an object hidden by a hand, decide three-dimensional positions of a plurality of keypoints for estimating a pose of the object, on the basis of the acquired information, train a machine learning model for estimating the decided positions of the plurality of keypoints in an input image, on the basis of an output when an image including the object and the hand is input to the trained machine learning model, acquire estimated positions of the keypoints in the image, and, on the basis of the estimated positions of the keypoints, decide an estimated pose of the object in a three-dimensional space.

In one mode of the present specification, the information indicating the portion hidden by the hand may include a plurality of images of the object gripped by the hand, and the one or the plurality of processors decide three-dimensional positions of the plurality of keypoints on the basis of frequencies at which a plurality of keypoint candidates decided by a predetermined procedure are hidden by the hand in the plurality of images of the object gripped by the hand.

In one mode of the present specification, the information indicating the portion hidden by the hand may include a portion of the object specified by a user and gripped by the hand.

In one mode of the present specification, the information indicating the portion hidden by the hand may include a portion of the object specified by a user and associated with a tag, and the one or the plurality of processors determine whether the portion associated with the tag is being operated by the hand, on the basis of the image including the object and the hand, and perform processing according to the tag when it is determined that the portion is being operated.

In one mode of the present specification, the one or the plurality of processors may determine whether the portion associated with the tag is being operated by the hand, on the basis of the image including the object and the hand, and perform processing according to the tag on the basis of a magnitude of the operation by the hand when it is determined that the portion is being operated.

Further, according to the present specification, there is provided a pose estimation method including, by one or a plurality of processors, acquiring information indicating a portion of an object hidden by a hand, deciding three-dimensional positions of a plurality of keypoints for estimating a pose of the object, on the basis of the acquired information, acquiring a trained machine learning model for estimating the decided positions of the plurality of keypoints in an input image, on the basis of an output when an image including the object and the hand is input to the acquired machine learning model, acquiring estimated positions of the keypoints in the image, and, on the basis of the estimated positions of the keypoints, estimating the pose of the object in a three-dimensional space.

Moreover, according to the present specification, there is provided a program for causing a computer to function as: acquiring means for acquiring information indicating a portion of an object hidden by a hand, keypoint decision means for deciding three-dimensional positions of a plurality of keypoints for estimating a pose of the object, on the basis of the acquired information, model acquiring means for acquiring a trained machine learning model for estimating the decided positions of the plurality of keypoints in an input image, position acquiring means for, on the basis of an output when an image including the object and the hand is input to the acquired machine learning model, acquiring estimated positions of the keypoints in the image, and, pose estimating means for, on the basis of the estimated positions of the keypoints, estimating the pose of the object in a three-dimensional space.

According to the present specification, it is possible to perform pose estimation using keypoints in a more appropriate manner.

### BRIEF DESCRIPTION OF THE DRAWINGS

FIG. 1 is a diagram illustrating an example of a configuration of an information processing system according to an implementation of the present specification.

FIG. 2 is a block diagram illustrating examples of functions implemented in the information processing system according to the implementation of the present specification.

FIG. 3 is a diagram illustrating an example of an image obtained by imaging an object.

FIG. 4 is a diagram for explaining examples of tag regions associated with function tags.

FIG. 5 is a flowchart schematically illustrating processing by the information processing system.

FIG. 6 is a flowchart illustrating an example of processing for decision of keypoints and learning of an estimation model.

FIG. 7 is a diagram for explaining examples of candidates for keypoints generated from an object.

FIG. 8 is a flowchart illustrating an example of processing for generating training data and training the estimation model.

FIG. 9 is a diagram illustrating an example of ground-truth data.

FIG. 10 is a flowchart illustrating another example of the processing for decision of keypoints and learning of the estimation model.

### DETAILED DESCRIPTION

Hereinafter, an implementation of the present specification is described in detail with reference to the figures. The present implementation describes a case of applying the specification to an information processing system that receives an input of an image obtained by imaging an object, estimates a pose of the object, and draws an image based on the estimated pose.

This information processing system includes a machine learning model that outputs information indicating a pose of an object estimated from an image in which the object is imaged.

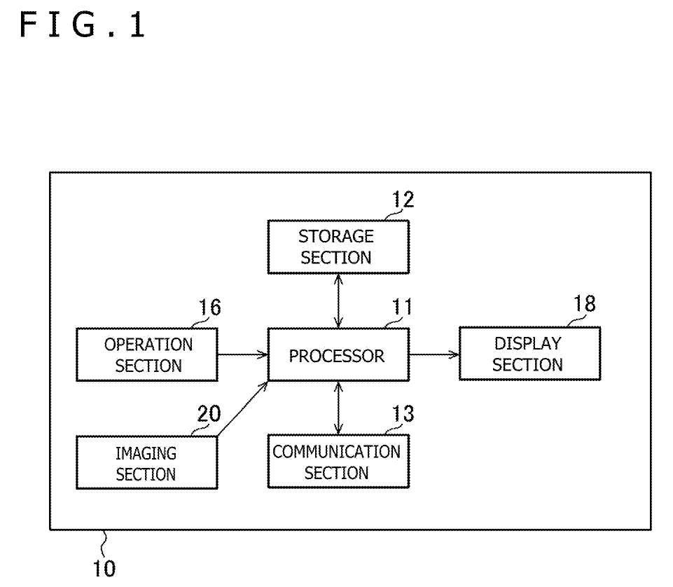

FIG. 1 is a diagram illustrating an example of a configuration of the information processing system according to the implementation of the present specification. The information processing system according to the present implementation includes an information processing apparatus 10. The information processing apparatus 10 is, for example, a computer such as a game console, a personal computer, or a VR headset. As illustrated in FIG. 1, the information processing apparatus 10 includes, for example, a processor 11, a storage section 12, a communication section 13, an operation section 16, a display section 18, and a imaging section 20. The information processing system may be configured by one information processing apparatus 10 or by a plurality of apparatuses including the information processing apparatus 10, and, for example, the imaging section 20 or the display section 18 may be disposed in a housing different from the information processing apparatus 10.

The processor 11 is, for example, a program control device such as a CPU that operates in accordance with a program installed in the information processing apparatus 10.

The storage section 12 includes at least some of a memory element such as a ROM or a RAM and an external storage device such as a solid state drive. The storage section 12 stores therein a program executed by the processor 11, and the like.

The communication section 13 is a communication interface for wired communication or wireless communication, for example, a network interface card, and transmits/receives data to/from another computer or a terminal via a computer network such as the Internet.

The operation section 16 is, for example, an input device such as a keyboard, a mouse, a touch panel, or a controller for a game console and receives an operation input made by a user and outputs to the processor 11 a signal indicating substances of the operation input.

The display section 18 is a display device such as a liquid-crystal display and displays various images according to instructions from the processor 11. The display section 18 may be incorporated in a VR headset or may be a device that outputs a video signal to an external display device.

The imaging section 20 is an imaging device including an image sensor. The imaging section 20 may be a camera capable of obtaining a visible RGB image. The imaging section 20 may be a camera capable of obtaining a visible RGB image and depth information synchronized with the RGB image. The imaging section 20 according to the present implementation may be, for example, a camera capable of imaging a moving image or may be a camera incorporated in a VR headset. The imaging section 20 may be provided outside the information processing apparatus 10, and in this case, the information processing apparatus 10 and the imaging section 20 may be connected to each other via the communication section 13 or an input/output section to be described later.

It is to be noted that the information processing apparatus 10 may include an audio input/output device such as a microphone or a speaker. Further, the information processing apparatus 10 may include, for example, a communication interface such as a network board, an optical disk drive for reading data from an optical disk such as a DVD-ROM or a Blu-ray (registered trademark) disk, and an input/output section (universal serial bus (USB) port) for inputting/outputting data to/from an external device.

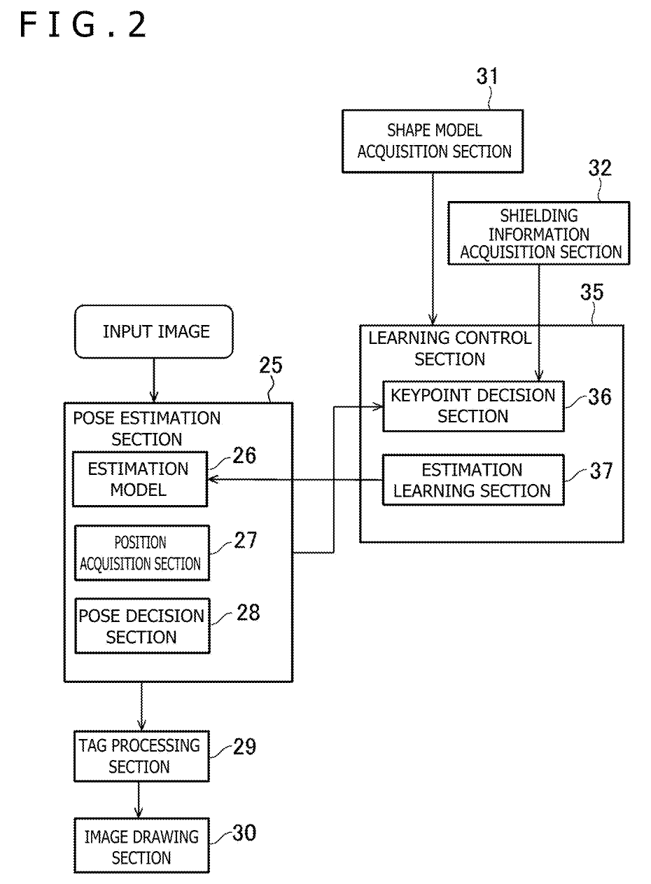

FIG. 2 is a block diagram illustrating examples of functions implemented in the information processing system according to the implementation of the present specification. As illustrated in FIG. 2, the information processing system functionally includes a pose estimation section 25, a tag processing section 29, an image drawing section 30, a shape model acquisition section 31, a occlusion information acquisition section 32, and a learning control section 35. The pose estimation section 25 functionally includes an estimation model 26, a position acquisition section 27, and a pose decision section 28. The learning control section 35 functionally includes a keypoint decision section 36 and an estimation learning section 37. The estimation model 26 is a kind of the machine learning model.

These functions are mainly implemented by the processor 11 and the storage section 12. More specifically, these functions may be implemented by the processor 11 executing a program that has been installed in the information processing apparatus 10 as a computer and that includes execution commands corresponding to the above functions. Alternatively, the program may be, for example, supplied to the information processing apparatus 10 via a computer-readable information storage medium such as an optical disk, a magnetic disk, or a flash memory, via the Internet, or by other module.

It is to be noted that all the functions illustrated in FIG. 2 do not necessarily need to be implemented in the information processing system according to the present implementation, and that functions other than those illustrated in FIG. 2 may be implemented in the information processing system according to the present implementation.

The pose estimation section 25 estimates a pose of an object as a target on the basis of information output when an input image is input to the estimation model 26. The input image is an image obtained by the imaging section 20 photographing the object. The estimation model 26 is a machine learning model and is trained on training data, and the trained estimation model 26 outputs data as an estimation result when input data is input thereto.

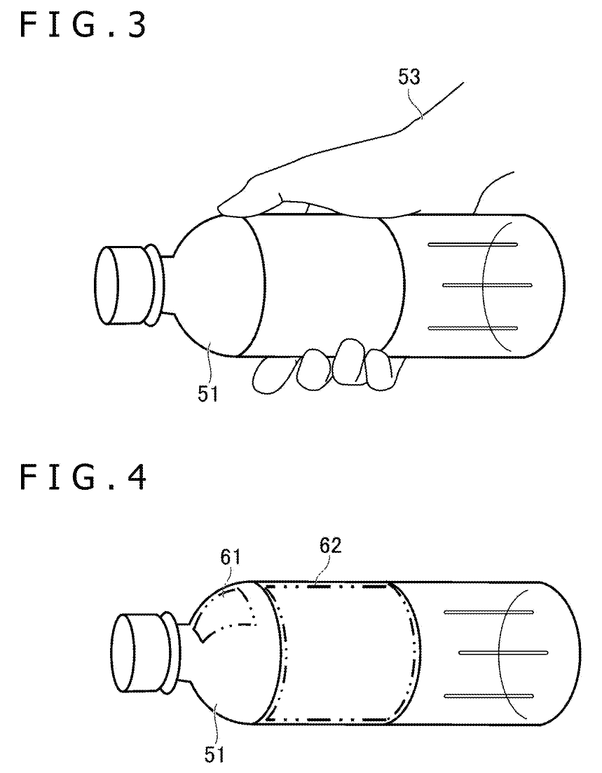

FIG. 3 is a diagram illustrating an example of the image in which the object is imaged. A target object 51 illustrated in FIG. 3 is held by a hand 53, for example, and imaged by the imaging section 20.

To the trained estimation model 26, information regarding an image in which the target object is imaged is input, and the estimation model 26 outputs information indicating a position of a keypoint for use in estimating the pose of the object. More specifically, the estimation model 26 outputs images indicating the position of each of a plurality of keypoints set for the object. The estimation model 26 may exist for each keypoint or for each keypoint candidate.

The training data for the estimation model 26 includes a plurality of learning images rendered using a three-dimensional shape model of the target object and ground-truth data indicating positions of keypoints of the object in the learning images. A keypoint is a virtual point in the object and is used in calculation of the pose. Data output from the estimation model 26 may be a position image in which each point indicates its positional relation (relative direction, for example) with respect to the keypoint or may be a position image in the form of a heatmap in which each point represents a probability that the keypoint exists at that position. Details of learning of the estimation model 26 will be described later.

The input image may be an image obtained by processing the image obtained by the imaging section 20 photographing the object. For example, the input image may be an image in which a region other than the target object is masked or may be an image in which the object in the image is enlarged or reduced to have a predetermined size.

On the basis of the output from the trained estimation model 26 when an image including the object and the hand is input to the estimation model 26, the position acquisition section 27 decides two-dimensional positions of the keypoints in the input image. For example, the position acquisition section 27 decides candidates for the two-dimensional positions of the keypoints in the input image on the basis of a position image output from the estimation model 26. The position acquisition section 27 calculates the positions of candidate points of the keypoints from combinations of any two points in the position image, for example, and generates a score for each position of the candidate points of the keypoints indicating whether the directions from the points in the position image toward the candidate points match the directions indicated by the points in the position image. The position acquisition section 27 may estimate, as the position of the keypoint, the candidate point having the highest score. Further, the position acquisition section 27 repeatedly performs the processing described above for each keypoint.

On the basis of the information indicating the two-dimensional position of the keypoint in the input image and information indicating a three-dimensional position of the keypoint in the three-dimensional shape model of the target object, the pose decision section 28 estimates the pose of the object and outputs pose data indicating the estimated pose. The pose of the object is estimated by a known algorithm. For example, estimation may be performed by a solution (EPnP, for example) to the Perspective-n-Point (PNP) problem regarding pose estimation. In addition, the pose decision section 28 may estimate not only the pose of the object, but also the position of the object in the input image, and the pose data may include information indicating the position.

It is assumed that the imaging section 20 acquires intrinsic parameters of the camera by calibration in advance. These parameters are used in solving the PnP problem.

Details of the estimation model 26, the position acquisition section 27, and the pose decision section 28 may be as described in the paper PVNet: Pixel-Wise Voting Network for 6DoF Pose Estimation.

On the basis of information indicating a portion of the object which portion is associated with a function tag and the image including the object and the hand, the tag processing section 29 determines whether the portion associated with the function tag is being operated by the hand. When it is determined that the portion is being operated by the hand, the tag processing section 29 performs processing according to the function tag. The tag processing section 29 may perform the processing according to the function tag on the basis of the magnitude of the operation by the hand when it is determined that the portion is being operated by the hand.

FIG. 4 is a diagram for explaining examples of tag regions 61 and 62 associated with function tags. Each of the tag regions 61 and 62 is a partial region of the target object 51. Each of the tag regions 61 and 62 may be a region on a surface of the target object 51 or may be a three-dimensional region including an inner portion of the target object 51. The tag regions 61 and 62 are associated with function tags different from each other. For example, the tag region 61 may be associated with a function tag for a switch, and the tag region 62 may be associated with a function tag for a portion to be gripped. Each of the tag regions 61 and 62 may be any of a region that a user can grip, a region at which a virtual touch screen can be displayed for touch interaction, and a region at which a light source is disposed or particles are ejected for the purpose of lighting, and the tag regions 61 and 62 may each be associated with a function tag corresponding to the relevant region.

The image drawing section 30 draws an image on the basis of the estimated pose of the object. The image drawing section 30 may draw a three-dimensional image of the object on the basis of the estimated pose of the object and the three-dimensional shape model. The image drawing section 30 may decide, on the basis of the estimated pose of the object, a pose of an object for drawing, for example, a VR image object, and draw the object for drawing.

The shape model acquisition section 31 acquires a plurality of photographed images obtained by the imaging section 20 photographing the target object. The shape model acquisition section 31 generates and acquires a three-dimensional shape model of the object from the plurality of photographed images. More specifically, the shape model acquisition section 31 extracts a plurality of feature vectors indicating local features of each of the plurality of photographed images and, from the plurality of feature vectors corresponding to each other which vectors have been extracted from the plurality of photographed images and positions in the photographed images at which the feature vectors have been extracted, obtains a three-dimensional position of the point at which the feature vectors have been extracted. Then, the shape model acquisition section 31 acquires a three-dimensional shape model of the object on the basis of the three-dimensional position. Since this method is a known method used also in software for realizing what is generally called SfM or Visual SLAM, detailed description is omitted.

The occlusion information acquisition section 32 acquires information indicating a portion of the target object hidden by the hand. It is assumed here that the hand is holding the object. The information indicating the portion hidden by the hand is, more specifically, at least some of a plurality of images in which the target object is gripped by the hand and information indicating a portion of the target object specified by the user as a portion to be gripped by the hand.

The occlusion information acquisition section 32 may acquire, as the information indicating the portion hidden by the hand, a plurality of images captured by the imaging section 20 in which the target object is gripped by the hand.

The occlusion information acquisition section 32 may acquire, as the information indicating the portion hidden by the hand, information indicating the portion of the object specified by the user and gripped by the hand. The tag regions 61 and 62 may be specified as the portion of the object.

The occlusion information acquisition section 32 may input information regarding the target object to a trained machine learning model that estimates a region to be held by the hand, and specify the portion of the object on the basis of the output of the machine learning model. Since this machine learning model is known, detailed description is omitted.

On the basis of the three-dimensional shape model of the target object, the learning control section 35 decides keypoints of the object and trains the estimation model 26.

The keypoint decision section 36 may decide, on the basis of the three-dimensional shape model of the target object and the information indicating the portion hidden by the hand, three-dimensional positions of a plurality of keypoints for estimating the pose of the target object. In the case in which the information indicating the portion hidden by the hand represents a plurality of images in which the object is gripped by the hand, the keypoint decision section 36 may decide a plurality of keypoints on the basis of frequencies at which a plurality of keypoint candidates decided by a predetermined technique are hidden by the hand in the plurality of images, and decide three-dimensional positions of the decided keypoints.

The keypoint decision section 36 may generate a set of a plurality of keypoint candidates by, for example, the known Farthest Point algorithm. For example, it is sufficient if the number N of keypoints is an integer of 4 or more and the number of keypoint candidates is an integer larger than the number N of keypoints (equal to or larger than 1.3 times the number of keypoints, for example).

In the case in which the information indicating the portion hidden by the hand represents information indicating the portion of the object specified by the user and gripped by the hand, the keypoint decision section 36 may decide a plurality of keypoints from the plurality of keypoint candidates on the basis of the portion and may decide three-dimensional positions of the decided keypoints.

The keypoint decision section 36 may decide a plurality of keypoints from the plurality of keypoint candidates, further on the basis of reliability of pose estimation using keypoints. A method for calculating the reliability will be described later.

The estimation learning section 37 trains the estimation model 26 that is a machine learning model for estimating positions of a plurality of decided keypoints in the input image. More specifically, the estimation learning section 37 generates training data for use in learning of the estimation model 26 and trains the estimation model 26 using the training data.

The training data includes a plurality of learning images rendered using the three-dimensional shape model of the target object and ground-truth data indicating positions of the keypoints of the object in the learning images. At least in initial training data, the keypoints that are the targets for generating ground-truth data by the estimation learning section 37 may be included in a set of keypoint candidates. The estimation learning section 37 may generate ground-truth data for all the keypoint candidates included in an initial set and train the estimation model 26.

More specifically, the estimation learning section 37 may decide positions of the keypoint candidates in the learning images on the basis of the rendered pose of the object and, for each of the keypoint candidates, generate a ground-truth position image corresponding to the position. It is to be noted that the training data may include learning images in which the object is imaged and position images generated from the pose of the object in the learning images which is estimated by what is generally called SfM or Visual SLAM.

In the present implementation, the estimation learning section 37 trains the estimation model 26 for each of the keypoint candidates. Further, the estimation model 26 for the selected keypoint candidate is used as the keypoint estimation model 26 in pose estimation (inference processing) for the input image.

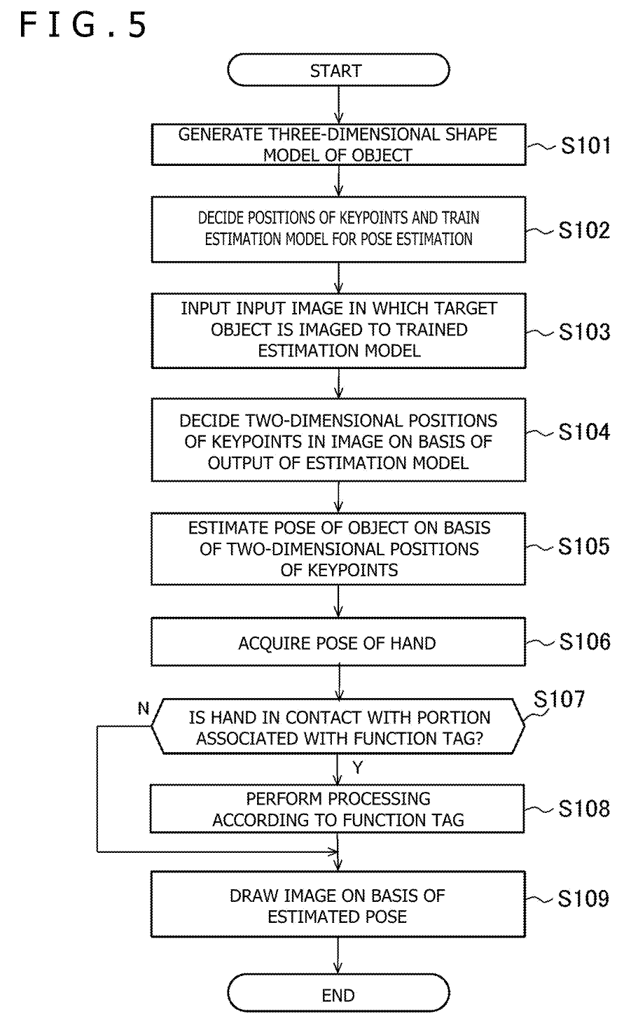

In the following, processing by the information processing system will be described. FIG. 5 is a flowchart schematically illustrating the processing by the information processing system.

First, on the basis of images in which the target object is imaged, the information processing system generates a three-dimensional shape model of the object by a known technique (S101).

Then, on the basis of the three-dimensional shape model and information indicating the portion hidden by the hand, the learning control section 35 included in the information processing system decides positions of keypoints and trains the estimation model 26 for pose estimation (S102).

After the estimation model 26 is trained, the pose estimation section 25 inputs an input image in which the object is imaged to the trained estimation model 26 (S103) and acquires output data of the estimation model 26. On the basis of the output of the estimation model 26, the pose estimation section 25 decides two-dimensional positions of the keypoints in the image (S104).

More specifically, in the case in which the output of the estimation model 26 is a position image in which each point indicates a relative direction to a keypoint, the position acquisition section 27 included in the pose estimation section 25 calculates keypoint position candidates from each point in the position image and decides the position of the keypoint on the basis the candidates. In the case in which the output of the estimation model 26 is a position image in the form of a heatmap, the position acquisition section 27 decides, as the position of the keypoint, the position of the point having the highest probability by a known method.

On the basis of the decided two-dimensional positions of the keypoints and the three-dimensional positions of the keypoints in the three-dimensional shape model, the pose estimation section 25 estimates the pose of the object (S105).

Further, the tag processing section 29 acquires information indicating a pose of the hand from the input image (S106). As the pose of the hand, an input image in which the hand and fingers are imaged or coordinates of joints of the hand and fingers in a three-dimensional space may be acquired. In the acquisition of the pose of the hand, a machine learning model trained using images and ground-truth data indicating joints may be used. The input image may include not only a visible image but also a depth image. Since the technique for acquiring the pose of the hand is known, detailed description is omitted.

On the acquired information indicating the pose of the hand, the tag processing section 29 determines whether the hand is in contact with the portion of the object which is associated with a function tag (S107). The tag processing section 29 may determine whether the hand is in contact with the portion associated with the function tag (tag region 61 or 62, for example), on the basis of whether or not a distance between the three-dimensional coordinates of any of the joints of the hand and the relevant portion is equal to or smaller than a threshold.

When it is determined that the hand is in contact with the portion associated with the function tag (S107), the tag processing section 29 performs processing according to the function tag associated with the relevant portion (S108). Conversely, when it is determined that the hand is not in contact with the portion associated with the function tag, processing of S108 is skipped.

Thereafter, the image drawing section 30 draws an image on the basis of the estimated pose (S108) and causes the drawn image to be displayed on the display section 18. The image may be displayed on another display.

Although the processing from S103 to S109 is performed once in the description of the example of FIG. 5, the processing from S103 to S109 is repeated in actual implementation, and pose estimation and image drawing are performed in real time according to movement of the object.

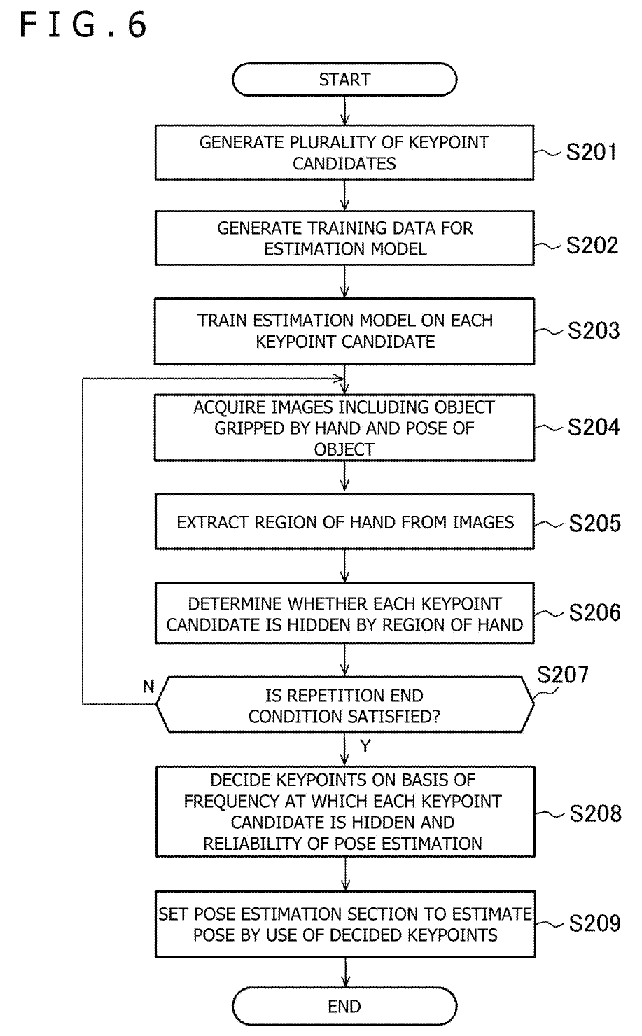

FIG. 6 is a flowchart illustrating an example of processing for decision of keypoints and learning of the estimation model 26. FIG. 6 is a flowchart for explaining the processing of S102 in FIG. 3 in more detail.

First, the keypoint decision section 36 generates a plurality of keypoint candidates (S201). More specifically, the keypoint decision section 36 may generate, from the three-dimensional shape model (more specifically, information regarding vertexes included in the three-dimensional shape model) of the object, a plurality of keypoint candidates and three-dimensional positions thereof by the known Farthest Point algorithm, for example.

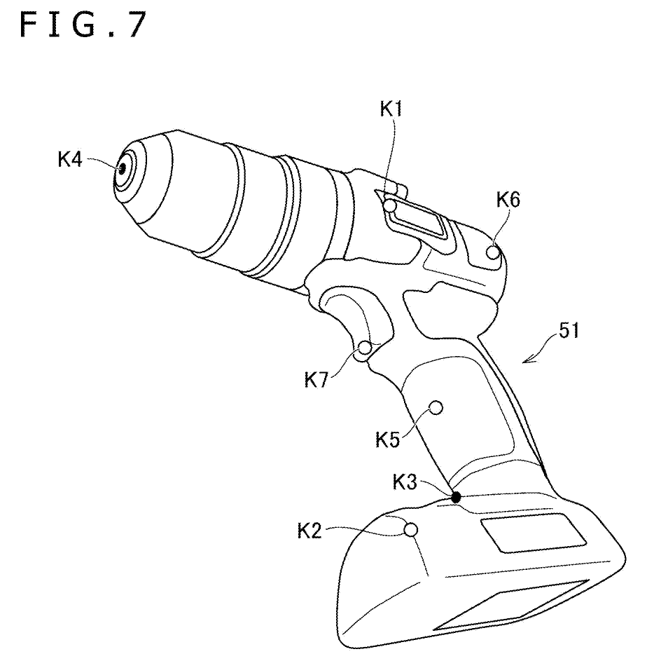

FIG. 7 is a diagram for explaining examples of the keypoint candidates generated from the object. FIG. 7 illustrates examples of keypoints generated in the case of targeting an object different from that in FIG. 3 and FIG. 4. In FIG. 7, for convenience of explanation, seven keypoint candidates K1 to K7 are indicated, but more keypoint candidates may be generated.

After the keypoint candidates are generated, the estimation learning section 37 generates training data for the estimation model 26 (S202). The training data includes training images rendered on the basis of the three-dimensional shape model and ground-truth data indicating positions of the respective keypoint candidates in the training images.

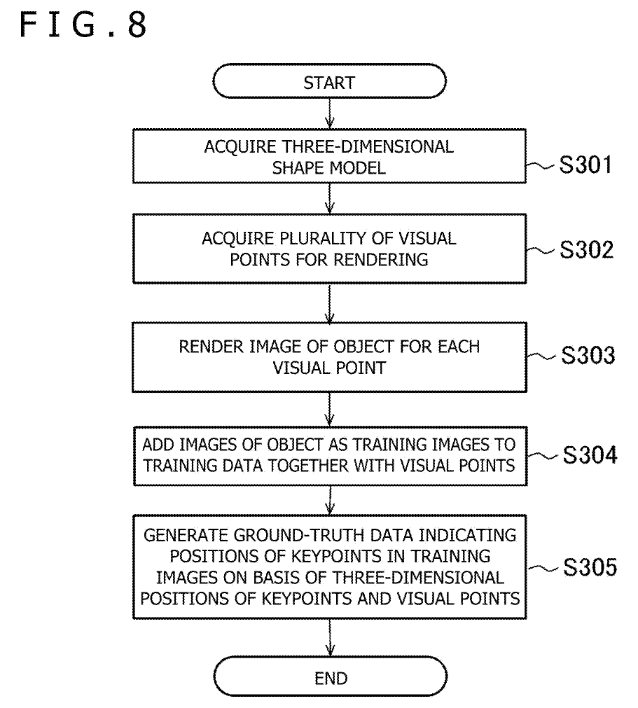

FIG. 8 is a flowchart illustrating an example of processing for generating training data. FIG. 8 is a flowchart for explaining the processing of S202 in more detail. First, the estimation learning section 37 acquires data regarding the three-dimensional shape model of the object (S301). Then, the estimation learning section 37 acquires a plurality of visual points for rendering (S302). More precisely, the estimation learning section 37 acquires a plurality of camera visual points for rendering and imaging directions corresponding to the camera visual points. The plurality of camera visual points may be provided at positions that maintain a constant distance from the origin of the three-dimensional shape model, and the imaging directions are directions from the camera visual points toward the origin of the three-dimensional shape model.

After the visual points are acquired, the estimation learning section 37 renders an image of the object for each of the visual points on the basis of the three-dimensional shape model (S303). The images may be rendered by a known technique.

After the images are rendered, the estimation learning section 37 adds the rendered images as training images to the training data together with the visual points (S304). Here, the estimation learning section 37 may perform predetermined data extension on the rendered images and treat the converted images as the training images. In the data extension technique, for example, it is also possible to perform, on a rendered image, such a conversion as applying a disturbance to at least some of luminance, saturation, and hue of the image, or cutting out part of the image and resizing the cut-out part to the original size.

The estimation learning section 37 may further add captured images of the object with visual points to the training images. The captured images may be captured images used in generation of the three-dimensional shape model. The camera visual points of the captured images may be camera visual points acquired at the time of generation of the three-dimensional shape model.

After the training images are prepared, the estimation learning section 37 generates, for each training image, ground-truth data indicating the positions of the keypoints in the training image on the basis of the three-dimensional positions of the keypoint candidates and the visual point of the training image (S305). The estimation learning section 37 generates, for each training image, ground-truth data for each keypoint candidate.

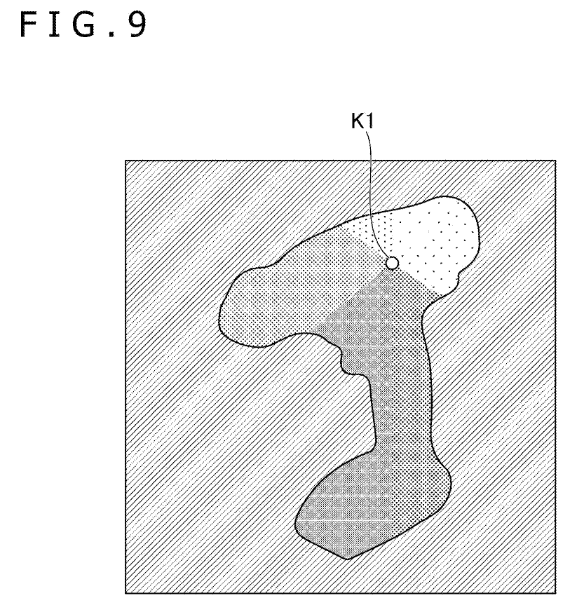

FIG. 9 is a diagram schematically illustrating an example of the ground-truth data. The ground-truth data is information indicating the two-dimensional position of the keypoint of the object in the training image and may be a position image in which each point indicates its positional relation (direction, for example) to the keypoint.

The position image may be generated for each kind of keypoint. The position image indicates, at each point, the relative direction between the point and the keypoint. In the position image illustrated in FIG. 9, a pattern corresponding to a value of each point is depicted, and the value of each point indicates the direction between the coordinates of the point and coordinates of the keypoint. FIG. 9 is merely a schematic diagram, and the actual value of each point continuously changes. The position image of FIG. 9 is a vector field image indicating, at each point, the relative direction from the point toward the keypoint.

As a result of the processing illustrated in FIG. 8, training data including the training images and the ground-truth data is generated.

After the training data is generated, the estimation learning section 37 trains the estimation model 26 for each keypoint candidate on the training data (S203). The trained estimation model 26 is used to detect the portion of the object hidden by the hand, by the following technique, for example.

After the estimation model 26 is trained, the keypoint decision section 36 outputs an instruction to the user to move, in front of the imaging section 20, the object gripped by the hand. In response to the instruction, the user moves the gripped object in front of the imaging section 20.

Then, the keypoint decision section 36 acquires images of the object gripped by the hand, the images being captured by the imaging section 20, and further acquires the pose of the object in the images (S204). The keypoint decision section 36 may acquire images constituting a video and in which the object is imaged. In acquisition of the pose of the object, the keypoint decision section 36 may decide two-dimensional positions of keypoint candidates on the basis of information output when an image is input to the trained estimation model 26, and may acquire the pose on the basis of the two-dimensional positions of the keypoint candidates and the positions thereof in the three-dimensional shape model by processing similar to that of the pose decision section 28. It is to be noted that, when a difference between the acquired pose and the pose acquired from previous images is equal to or smaller than a threshold or when the images of the object and the images captured previously are similar to each other, the keypoint decision section 36 may discard the images and repeat the processing of S204.

It is to be noted that, if the acquisition of the pose fails due to a failure in the estimation of keypoints, for example, the keypoint decision section 36 may acquire the images and the pose of the object by causing the user to adjust the pose of the object to a specified pose. The keypoint decision section 36 may cause a VR headset or the like to display a rendered image of a specified object and cause the position and pose of the gripped object to be adjusted in such a manner as to overlap the rendered image.

After the images are acquired, the keypoint decision section 36 extracts a region of the hand from each of the images (S205). The extraction of the region of the hand may be performed simply on the basis of color or may be performed by a known machine learning model that has been trained.

The keypoint decision section 36 determines whether each of the keypoint candidates is hidden by the extracted region of the hand (S206). The keypoint decision section 36 may determine that the keypoint candidate is hidden, when the position of the keypoint candidate in the image is in the extracted region of the hand.

Then, the keypoint decision section 36 checks whether a repetition end condition is satisfied (S208). The repetition end condition may be establishment of a state in which the number of images that have been subjected to the determination is equal to or larger than a threshold, or may be establishment of a state in which, when a surface of a virtual sphere surrounding the object is divided into a plurality of portions, all the portions are associated with the pose. The portion existing in a direction indicated by the pose acquired from the images may be the portion associated with the pose.

When the repetition end condition is not satisfied (N in S207), processing of S204 and the subsequent steps is repeated. When the repetition end condition is satisfied (Y in S207), conversely, the keypoint decision section 36 decides keypoints on the basis of the frequency at which each keypoint candidate is determined as being hidden and the reliability of pose estimation (S208).

More specifically, the keypoint decision section 36 selects a provisional set of keypoints from the plurality of keypoint candidates on the basis of the frequency at which each keypoint candidate is determined as being hidden. As an initial provisional set, a predetermined number of keypoints may be selected among the keypoint candidates in an ascending order of the frequency of being hidden. The keypoint decision section 36 acquires, for the selected keypoints, the reliability of pose estimation assuming that the pose estimation section 25 performs pose estimation on the images acquired in S204.

The reliability may be decided on the basis of the pose of the object estimated by the pose decision section 28 and the correct pose thereof. For example, the keypoint decision section 36 may calculate, as the truth-grounded pose, the pose obtained from the images by the SLAM technology or the like and calculate the reliability on the basis of a difference between the truth-grounded pose and the estimated pose.

Further, on the basis of the pose estimated from the provisional keypoints and the three-dimensional positions of the keypoint candidates, the keypoint decision section 36 may reproject the respective positions of the keypoint candidates in the images and store the reprojected positions in the storage section 12. In this case, for each keypoint candidate, the keypoint decision section 36 may calculate, as the reliability, an average of distances between the positions estimated from the output of the estimation model 26 and the reprojected positions.

When the reliability is higher than a threshold, the keypoint decision section 36 decides the set of keypoints as proper keypoints, and when the reliability is not higher than the threshold, the keypoint decision section 36 selects a provisional set of keypoints different from the set selected so far from the plurality of keypoint candidates and repeats the processing subsequent to the acquisition of reliability. The newly selected provisional set may be, for example, generated by replacing keypoints randomly selected from the original set of keypoints with any of unselected keypoint candidates. The keypoint candidates to be replaced may be decided, for example, on the basis of a score calculated from their low frequency of being hidden and their distance from the keypoints in the existing set.

After the set of keypoints is decided, the learning control section 35 sets the pose estimation section 25 to estimate the pose by use of the decided set of keypoints (S209). It is to be noted that the estimation model 26 used in actual pose estimation may be one that has trained on the keypoints (keypoint candidates).

As a result of the processing from S204 to S208, keypoints liable to be hidden by the hand and having a high probability of negatively affecting estimation of the accuracy of pose estimation are efficiently excluded, and the pose estimation can be performed more efficiently. Further, additionally using the reliability of pose estimation enables, for example, prevention of a reduction in accuracy of pose estimation attributable to concentration of keypoints in a small area. Moreover, since it is possible to exclude in advance keypoint candidates having a low degree of contribution to pose estimation, both high accuracy and high-speed processing in pose estimation are realized, so that the efficiency of processing can be improved.

It is to be noted that the keypoint candidates targeted by the processing in S208 may be those having a frequency of being hidden equal to or lower than a threshold. In this case, if the number of keypoint candidates is smaller than the value obtained by adding a predetermined number (2, for example) to the number of keypoints, the keypoint decision section 36 may generate additional keypoint candidates to replace the keypoint candidates having a frequency of being hidden higher than the threshold, and perform again the processing subsequent to S202 on the replacing keypoint candidates.

While the portion actually hidden by the hand is acquired in the processing illustrated in FIG. 6, information indicating the portion of the object specified by the user and gripped by the hand may be acquired instead as the information indicating the portion hidden by the hand.

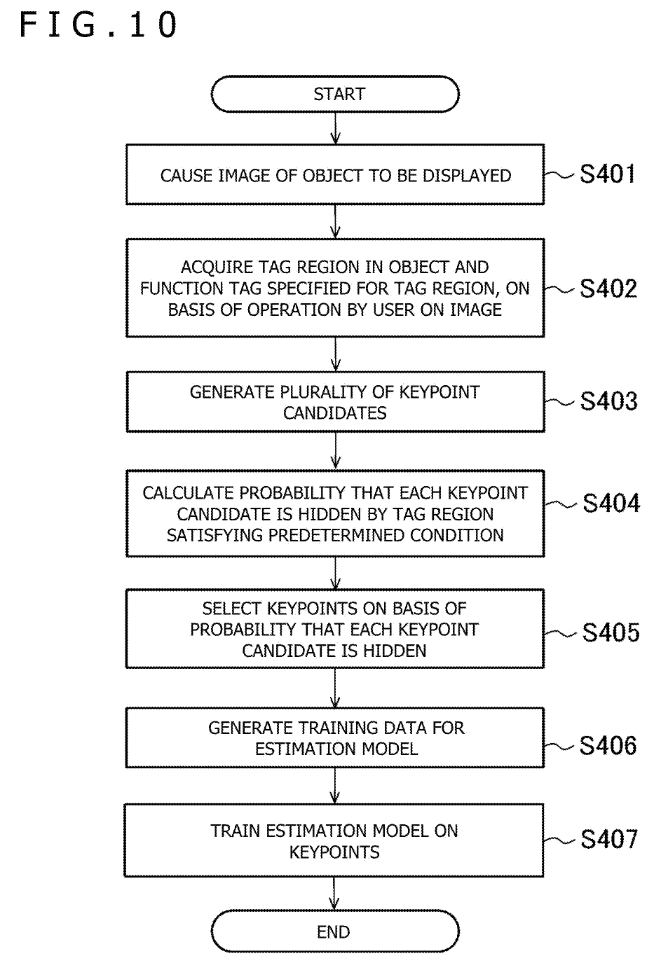

FIG. 10 is a flowchart illustrating another example of the processing for decision of keypoints and learning of the estimation model 26. In this example, on an image of the object displayed on the display, the user manually specifies the portion hidden by the hand, as a tag region.

First, the keypoint decision section 36 causes an image of the object to be displayed on the basis of the three-dimensional shape model (S401). Next, on the basis of an operation by the user on the image, a tag region specified by the user in the object and a function tag specified for the tag region are acquired (S402).

The keypoint decision section 36 may perform processing for causing an icon for a painting tool including a paint palette to be displayed together with the image of the object and causing a scanned model to be colored using a color specified by the user on the paint palette. It is to be noted that the user may paint any position of the object while holding the object. In this case, a transparent image of a virtual object having a shape same as that of the actual object may be superimposed on the image of the actual object, and the virtual object may be colored, so that the relevant region is visualized as if the actual object were colored. Further, colors of the paint may be associated with function tags.

The keypoint decision section 36 may acquire the colored region as a tag region. Moreover, in place of coloring by use of the painting tool, the keypoint decision section 36 may specify a tag region by causing the user to select any of a plurality of virtual stickers corresponding to respective function tags and apply the selected virtual sticker to the object.

In parallel with S401 and S402, the keypoint decision section 36 generates a plurality of keypoint candidates (S403). Since this processing is similar to S201, detailed description is omitted.

The keypoint decision section 36 calculates the probability that each keypoint candidate is hidden by a tag region satisfying a predetermined condition (S404). The tag region satisfying the predetermined condition may be, for example, a tag region specified as a region to be gripped or a tag region associated with a function of being touched by the hand such as a switch.

The keypoint decision section 36 may, for example, cast rays in a plurality of directions (isotropically) from a keypoint candidate and calculate, as the probability at the keypoint candidate, a value indicating a ratio of rays hitting a tag region. Further, in a case in which a tag region is a three-dimensional region, the keypoint decision section 36 may set the value of probability to 1 when the keypoint candidate is within the region and 0 when it is outside the region.

The keypoint decision section 36 selects keypoints to be used in final pose estimation, on the basis of the probability that each keypoint candidate is hidden (S405). Here, the keypoint decision section 36 may select a predetermined number of keypoints from the keypoint candidates in an ascending order of the probability.

Besides, the keypoint decision section 36 may select keypoints on the basis of the reliability and the probability. For example, the keypoint decision section 36 may decide provisional keypoints and calculate the reliability on the basis of the provisional keypoints. From the reliability and probability of each keypoint, the keypoint decision section 36 generates a score representing suitability as a keypoint and decides keypoints on the basis of the scores. The calculation of the reliability may be performed in the following procedure. First, by use of the estimation model 26 having been trained on the provisional keypoints, the pose estimation section 25 estimates the pose in the images captured in generating of the three-dimensional shape model. Next, the keypoint decision section 36 reprojects the position of each keypoint candidate in the image on the basis of the estimated pose and the three-dimensional position of each of the keypoint candidates. Then, the keypoint decision section 36 calculates, as the reliability, an average distance between the position estimated from the output of the estimation model 26 and the reprojected position, for each keypoint candidate. It is to be noted that keypoints may be decided in a repetitive manner by a technique similar to that in the case of S208.

After the keypoints are decided, the estimation learning section 37 generates training data for learning of the estimation model 26 for each keypoint candidate (S406). Further, the estimation learning section 37 trains the estimation model 26 on each keypoint (S407). It is to be noted that, in a case in which the estimation model 26 has trained on keypoints (keypoint candidates) in advance, redundant training of the estimation model 26 need not be performed.

Also by the technique illustrated in FIG. 10, the keypoints liable to be hidden by the hand and having a high probability of negatively affecting pose estimation in the case of the object gripped by the hand are efficiently excluded, and the pose estimation can be performed more efficiently. Moreover, since it is possible to exclude in advance keypoint candidates having a low degree of contribution to pose estimation, both high accuracy and high-speed processing in pose estimation are realized, so that the efficiency of processing can be improved.

Moreover, by the technique illustrated in FIG. 10, the portion hidden by the hand is identified by some function assigned thereto. Therefore, it is possible to omit an operation for identifying the portion itself hidden by the hand, so that convenience is improved.

It is to be noted that the specific numerical values described above and the objects and numerical values in the figures are illustrative and not limitative, and they may be modified as needed.

What is claimed is:

1. A pose estimation system comprising:
one or more computer processors; and
one or more non-transitory computer-readable media that store instructions which,when executed by the one or more computer processors, cause the one or more computer processors to perform operations comprising:
obtaining information indicating a portion of an object hidden by a hand,
determining three-dimensional positions of a plurality of keypoints for estimating a pose of the object, on a basis of the obtained information,
training a machine learning model for estimating the decided positions of the plurality of keypoints in an input image,
based at least on an output when an image including the object and the hand is input to the trained machine learning model, obtaining estimated positions of the keypoints in the image, and,
based at least on the estimated positions of the keypoints, determining an estimated pose of the object in a three-dimensional space.

2. The pose estimation system of claim 1, wherein:
the information indicating the portion hidden by the hand includes a plurality of images of the object gripped by the hand, and
the operations further comprise determining three-dimensional positions of the plurality of keypoints based at least on frequencies at which a plurality of keypoint candidates decided by a predetermined procedure are hidden by the hand in the plurality of images of the object gripped by the hand.

3. The pose estimation system of claim 1, wherein the information indicating the portion hidden by the hand includes a portion of the object specified by a user and gripped by the hand.

4. The pose estimation system according to claim 3, wherein:
the information indicating the portion hidden by the hand includes a portion of the object specified by a user and associated with a tag, and
the operations comprise:
determining determine whether the portion associated with the tag is being operated by the hand, based at least on the image including the object and the hand, and
performing processing according to the tag when determining that the portion is being operated.

5. The pose estimation system according to claim 4, wherein the operations comprise:
determining whether the portion associated with the tag is being operated by the hand, based at least on the image including the object and the hand, and
performing processing according to the tag on a basis of a magnitude of the operation by the hand when determining that the portion is being operated.

6. The pose estimation system of claim 1, wherein the one or more processors are included in a gaming console.

7. The pose estimation system of claim 1, wherein the one or more processors are included in a virtual reality (VR) headset.

8. One or more non-transitory computer-readable media that store instructions which,when executed by one or more computer processors, cause the one or more computer processors to perform operations comprising:
obtaining information indicating a portion of an object hidden by a hand,
determining three-dimensional positions of a plurality of keypoints for estimating a pose of the object, on a basis of the obtained information,
training a machine learning model for estimating the decided positions of the plurality of keypoints in an input image,
based at least on an output when an image including the object and the hand is input to the trained machine learning model, obtaining estimated positions of the keypoints in the image, and,
based at least on the estimated positions of the keypoints, determining an estimated pose of the object in a three-dimensional space.

9. The media of claim 8, wherein:
the information indicating the portion hidden by the hand includes a plurality of images of the object gripped by the hand, and
the operations further comprise determining three-dimensional positions of the plurality of keypoints based at least on frequencies at which a plurality of keypoint candidates decided by a predetermined procedure are hidden by the hand in the plurality of images of the object gripped by the hand.

10. The media of claim 8, wherein the information indicating the portion hidden by the hand includes a portion of the object specified by a user and gripped by the hand.

11. The media of claim 10, wherein:
the information indicating the portion hidden by the hand includes a portion of the object specified by a user and associated with a tag, and
the operations comprise:
determining determine whether the portion associated with the tag is being operated by the hand, based at least on the image including the object and the hand, and
performing processing according to the tag when determining that the portion is being operated.

12. The media of claim 11, wherein the operations comprise:
determining whether the portion associated with the tag is being operated by the hand, based at least on the image including the object and the hand, and
performing processing according to the tag on a basis of a magnitude of the operation by the hand when determining that the portion is being operated.

13. The media of claim 8, wherein the one or more processors are included in a gaming console.

14. The media of claim 8, wherein the one or more processors are included in a virtual reality (VR) headset.

15. A computer-implemented method comprising:
obtaining information indicating a portion of an object hidden by a hand,
determining three-dimensional positions of a plurality of keypoints for estimating a pose of the object, on a basis of the obtained information,
training a machine learning model for estimating the decided positions of the plurality of keypoints in an input image,
based at least on an output when an image including the object and the hand is input to the trained machine learning model, obtaining estimated positions of the keypoints in the image, and,
based at least on the estimated positions of the keypoints, determining an estimated pose of the object in a three-dimensional space.

16. The method of claim 15, wherein:
the information indicating the portion hidden by the hand includes a plurality of images of the object gripped by the hand,
the method comprises determining three-dimensional positions of the plurality of keypoints based at least on frequencies at which a plurality of keypoint candidates decided by a predetermined procedure are hidden by the hand in the plurality of images of the object gripped by the hand.

17. The method of claim 15, wherein the information indicating the portion hidden by the hand includes a portion of the object specified by a user and gripped by the hand.

18. The method of claim 17, wherein:
the information indicating the portion hidden by the hand includes a portion of the object specified by a user and associated with a tag, and
the method comprises:
determining determine whether the portion associated with the tag is being operated by the hand, based at least on the image including the object and the hand, and
performing processing according to the tag when determining that the portion is being operated.

19. The method of claim 18, comprising comprise:
determining whether the portion associated with the tag is being operated by the hand, based at least on the image including the object and the hand, and
performing processing according to the tag on a basis of a magnitude of the operation by the hand when determining that the portion is being operated.

20. The method of claim 15, wherein the one or more processors are included in a gaming console.
